(19) United States
(12) Patent Application Publication
(10) Pub. No.: US 2026/0170611 A1
(43) Pub. Date: Jun. 18, 2026

(54) ENHANCED HIGH DYNAMIC RANGE (HDR) COLOR IMAGES

(71) Applicant: Samsung Electronics Co., Ltd., Suwon-si (KR)

(72) Inventors: Sanjana Gunna, Irvine, CA (US); Chenguang Liu, Tustin, CA (US); Chang Su, Foothill Ranch, CA (US)

(21) Appl. No.: 19/409,323

(22) Filed: Dec. 4, 2025

Related U.S. Application Data
(60) Provisional application No. 63/733,316, filed on Dec. 12, 2024.
(60) Provisional application No. 63/802,474, filed on May 8, 2025.

(51) Int. Cl. G06T 5/50; G06T 5/40

(52) U.S. Cl. CPC G06T 5/50; G06T 5/40; G06T 2207/10024; G06T 2207/20208

(57) ABSTRACT

A method includes receiving, using at least one processing device of an electronic device, two-dimensional (2D) hue-saturation color metadata corresponding to high dynamic range (HDR) source content. The method also includes performing a scene-adaptive color enhancing process to build a saturation enhancing model based on the 2D hue-saturation color metadata. The method further includes performing hue interpolation, based on the saturation enhancing model, to preserve color hue accuracy while enhancing saturation. In addition, the method includes generating, based on the HDR source content and the hue interpolation, output image data corresponding to the HDR source content and having enhanced color content.

### CROSS-REFERENCE TO RELATED APPLICATIONS AND PRIORITY CLAIM

This application claims priority under 35 U.S.C. § 119(e) to U.S. Provisional Patent Application Nos. 63/802,474 filed on May 8, 2025 and 63/733,316 filed on Dec. 12, 2024, both of which are hereby incorporated by reference in their entireties.

### TECHNICAL FIELD

This disclosure relates generally to imaging systems and processes. More specifically, this disclosure relates to systems and methods for producing enhanced high dynamic range (HDR) color images.

### BACKGROUND

When high dynamic range (HDR) images are captured, mastered, or displayed within a narrow color gamut (NCG), one consequence is a perceptual mismatch between the content's luminance range and its chromatic breadth. HDR increases contrast and highlight detail. However, if color primaries remain constrained, hues cannot fully saturate and expand as brightness rises. The result is imagery that appears tonally impressive yet chromatically starved, such as when the sky skews toward dull cyans, foliage flattens into uniform greens, and specular highlights carry brightness without corresponding color intensities. This undermines the intended “pop” of HDR, introduces a sense of desaturation at mid-to-high luminance levels, and exaggerates banding or clipping when colors push against the limited boundary of the smaller gamut. Creatively, it compromises scene mood and material cues in that skin tones, fabrics, metals, and neon lighting lose nuanced hue separation that HDR is meant to reveal.

### SUMMARY

This disclosure provides systems and methods for producing enhanced high dynamic range (HDR) color images.

In a first embodiment, a method includes receiving, using at least one processing device of an electronic device, two-dimensional (2D) hue-saturation color metadata corresponding to high dynamic range (HDR) source content. The method also includes performing, using the at least one processing device, a scene-adaptive color enhancing process to build a saturation enhancing model based on the 2D hue-saturation color metadata. The method further includes performing, using the at least one processing device, hue interpolation, based on the saturation enhancing model, to preserve color hue accuracy while enhancing saturation. In addition, the method includes generating, using the at least one processing device and based on the HDR source content and the hue interpolation, output image data corresponding to the HDR source content and having enhanced color content.

In some disclosed embodiments, the scene-adaptive color enhancing process may include generating one or more cumulative distribution function (CDF) curves in a saturation dimension based on the 2D hue-saturation color metadata. In some disclosed embodiments, the scene-adaptive color enhancing process may include dynamically shifting the one or more CDF curves in the saturation dimension in accordance with one or more scene-adaptive lookup tables (LUTs). In some disclosed embodiments, the scene-adaptive color enhancing process may be configured to use the 2D hue-saturation color metadata based on the one or more CDF curves in the saturation dimension.

In some disclosed embodiments, the 2D hue-saturation color metadata may include a histogram generated from the HDR source content with fixed hue quantization boundaries and dynamically-determined saturation boundaries. In some disclosed embodiments, the fixed hue quantization boundaries may include six hue ranges, and the dynamically-determined saturation boundaries may include five saturation divisions.

In some disclosed embodiments, performing the scene-adaptive color enhancing process may include generating CDF curves along a saturation dimension from the 2D hue-saturation color metadata. In some disclosed embodiments, performing the hue interpolation may include interpolating, for a plurality of hue values extracted from the HDR source content, an augmented CDF matrix in two dimensions to obtain CDF values for the plurality of hue values.

Some disclosed embodiments may include shifting the CDF curves by applying a horizontal shift to saturation control points and a vertical shift to CDF values to produce shifted CDF curves. The horizontal shift may be based on slope values of the CDF curves across saturation ranges, and the vertical shift may be based on a fraction of a CDF value range.

In some disclosed embodiments, the saturation enhancing model may be constructed to modify only a saturation channel while preserving a luminance channel and a hue channel of the HDR source content.

Another embodiment includes a method that includes receiving, by an electronic device, low-dynamic range image data having a narrower color gamut. The method also includes dynamically updating, using at least one digital signal processing device of the electronic device and based on the low-dynamic range image data, a three-dimensional (3D) lookup table (LUT) in digital signal processing (DSP) with hue fidelity processing. The method further includes maintaining, using the at least one digital signal processing device and based on the hue fidelity processing, an input hue quality as perceived by a human vision system (HVS). In addition, the method include performing, using at least one chipset of the electronic device, pixel-wise processing of the low-dynamic range image data to produce high-dynamic range image data having a wider color gamut, where the pixel-wise processing includes interpolation.

In various embodiments, one or more first higher-cost color-enhancing tasks may be performed by a device other than the electronic device (which may be referred to as “off-device processing”), and one or more second higher-cost color-enhancing tasks may be performed by the electronic device (which may be referred to as “on-device processing”).

In various embodiments, dynamically updating the 3D LUT may include updating the 3D LUT on a frame-wise basis using scene statistics determined from the low-dynamic-range image data. In various embodiments, dynamically updating the 3D LUT may include updating the 3D LUT on a scene-wise basis responsive to detection of scene changes in the low-dynamic range image data.

In some embodiments, the hue fidelity processing may include enforcing hue-invariant mapping in a perceptual color space so as to reduce visible hue distortions as perceived by the HVS.

In some embodiments, dynamically updating the 3D LUT may include generating a set of anchor colors based on off-device processing and updating, in the digital signal processing device, the 3D LUT using the set of anchor colors. In various embodiments, the off-device processing may include executing one or more computationally-expensive nonlinear operators including at least one of an exponential function, a logarithmic function, or a trigonometric function to generate the set of anchor colors.

In some embodiments, performing the pixel-wise processing may include performing gamut mapping that constrains output colors to a target color gamut while preserving hue and minimizing clipping artifacts.

In some embodiments, dynamically updating the 3D LUT may include adapting one or more saturation expansion parameters based on one or more statistics including at least one of chroma histogram features, average saturation, scene contrast, or luminance percentile measures.

In various embodiments, the interpolation for the pixel-wise processing may be performed only by the chipset, and the hue fidelity processing and 3D LUT updates may be performed exclusively in the DSP device.

Other embodiments include an electronic device having at least one processor and/or chipset configured to perform any of the embodiments of the methods above.

Still other embodiments include a non-transitory machine-readable medium contains instructions that when executed cause at least one processor of an electronic device to perform any of the embodiments of the methods above.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example process for constructing color metadata according to this disclosure;

FIG. 3 illustrates example color metadata represented as a normalized histogram with counts/probability of each division of saturation and hue in accordance with this disclosure;

FIG. 4 illustrates an example of processing-intensive high dynamic range (HDR) content creation with dynamic color metadata in accordance with this disclosure;

FIG. 5 illustrates an example process for a color enhancing/expansion to produce color-enhanced HDR content according to this disclosure;

FIG. 6 illustrates a specific example implementation of an electronic device having a digital signal processor, shared random access memory, and system-on-a-chip in accordance with this disclosure;

FIG. 7 illustrates an example method for producing image data according to this disclosure;

FIG. 8 illustrates another specific example implementation of an electronic device having a digital signal processor, shared random access memory, and system-on-a-chip in accordance with this disclosure;

FIG. 9 illustrates example processes that can be performed by an electronic device in accordance with this disclosure;

FIG. 10 illustrates other example processes that can be performed by an electronic device in accordance with this disclosure; and

FIG. 11 illustrates an example method for producing image data according to this disclosure.

### DETAILED DESCRIPTION

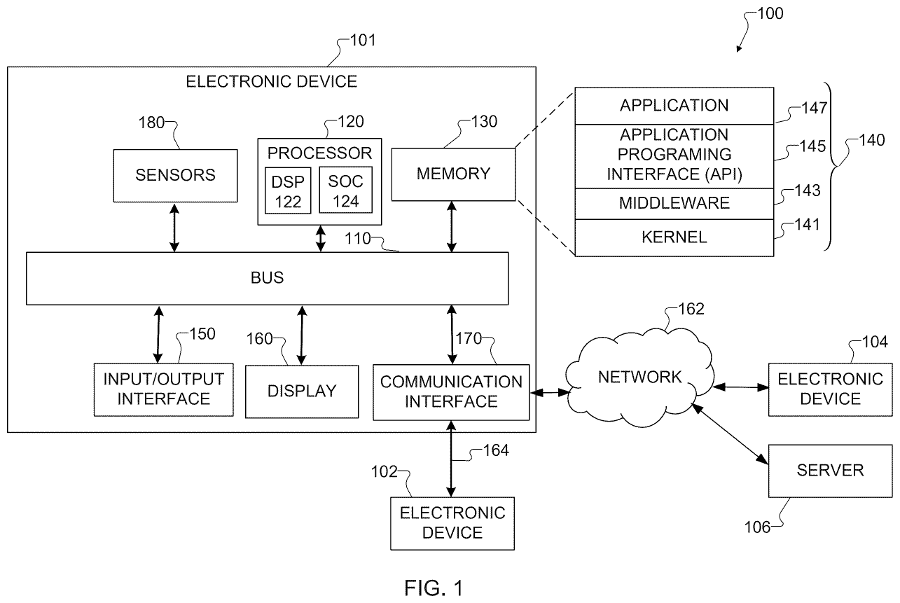

FIGS. 1 through 11, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, when high dynamic range (HDR) images are captured, mastered, or displayed within a narrow color gamut (NCG), one consequence is a perceptual mismatch between the content's luminance range and its chromatic breadth. HDR increases contrast and highlight detail. However, if color primaries remain constrained, hues cannot fully saturate and expand as brightness rises. The result is imagery that appears tonally impressive yet chromatically starved, such as when the sky skews toward dull cyans, foliage flattens into uniform greens, and specular highlights carry brightness without corresponding color intensities. This undermines the intended “pop” of HDR, introduces a sense of desaturation at mid-to-high luminance levels, and exaggerates banding or clipping when colors push against the limited boundary of the smaller gamut. Creatively, it compromises scene mood and material cues in that skin tones, fabrics, metals, and neon lighting lose nuanced hue separation that HDR is meant to reveal.

On consumer displays capable of wide color gamuts, NCG masters trigger suboptimal up-conversions. Static or naïve gamut expansions tend to either overshoot into artifacts (such as haloing, hue rotation, and skin oversaturation) or undershoot into washed-out results, especially as scene content changes. Without content-adaptive, hue-preserving expansion to a wider gamut, HDR images exhibit vivid highlights with mediocre color, reduced material realism, and unstable color rendition across the image. This diminishes both creative intent and the viewer's perceived quality. Color is a vital component of multimedia content on visual display electronic devices, and people generally prefer colors that are brighter and more vivid.

Among other things, this disclosure provides systems and methods for producing enhanced HDR color images. Various embodiments include systems and methods that employ color-based metadata and enhancing processes to render visual content with improved color quality while keeping images as close to their original creative intent as possible. As used here, HDR can refer to existing standards, such as HDR10 and HDR10+, but more generally refers to images with a relatively higher dynamic range than other lower-dynamic range images, including those known as standard-dynamic-range (SDR) images. Enhanced color content can refer to improved HDR color content.

In some embodiments, the disclosed embodiments include an architecture that dynamically updates a 3D color LUT based on content-adaptive statistics information in digital signal processing (DSP) and carries out color enhancing/expansion with fixed super low-cost hardware. Using disclosed techniques, different color enhancing algorithms can be implemented and updated in DSP (software) only without any additional modification in hardware. Any dynamic color enhancing algorithm can be implemented through software updates, and hardware costs can be reduced and deploying efficiencies of color enhancing algorithms can be improved.

Note that while various embodiments discussed below are described in the context of use in consumer electronic devices (such as smart phones and televisions), this is merely one example. It will be understood that the principles of this disclosure may be implemented in any number of other suitable contexts.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, at least one processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). As a particular example, the at least one processor 120 may include a digital signal processor (DSP) 122 and/or a system-on-a-chip (SOC) 124. The processor 120 is able to perform control on at least one of the other components of the electronic device 101 and/or perform an operation or data processing relating to communication or other functions. As described below, the processor 120 may perform one or more operations for producing enhanced HDR color images.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for producing enhanced HDR color images as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the at least one processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the at least one processor 120 implemented in the electronic device 101. As described in more detail below, the server 106 may perform one or more operations for producing enhanced HDR color images.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

In order to improve the color of image content, in some embodiments, disclosed processes can extract and process information about color of original source HDR content. As used here, “color metadata” refers to color information extracted from original HDR content, which could include dynamic HDR10+ metadata based on brightness. HDR10+ specifications and other information are known to those of skill in the art (see hdr10plus.org). Disclosed embodiments can include one or more ways of modeling color information, and specific embodiments can employ a low-cost and robust process for modeling descriptive color information to extract more important properties. Some embodiments improve saturation of input content while leaving luma channel data undisturbed.

Disclosed embodiments can include processes that enhance color of source HDR content using the color metadata. For example, in various embodiments, color metadata can be built on hue and saturation statistics of original source HDR content and can be provided along with dynamic HDR10+ metadata or other metadata for color enhancement purposes. In some embodiments, a design of the metadata can be based on creating a 2D histogram operating on the hue and saturation statistics. The size of the metadata can also be useful or important to both the quality of the results and the cost of storage and transmission. Disclosed embodiments can provide a distinct technical advantage in providing high-quality results with a reduced or minimum amount of metadata, balancing image quality and storage requirements. For example, in some implementations of color metadata, the color metadata uses six quantization boundaries for hue and five divisions for saturation. While specific embodiments use 2D histograms, other embodiments can use histograms having three or more dimensions.

In some cases, disclosed embodiments can operate in the “CIELCH” color space. CIELCH (also called CIE LCH or simply LCH) is known to those of skill in the art as a color space that describes colors using lightness, chroma, and hue. It is a cylindrical representation of the CIELAB color space and is designed to be perceptually uniform, meaning it corresponds to how the human eye perceives color differences. In this model, lightness (L*) is a vertical axis, while chroma (C*) and hue (H^{∘}) are polar coordinates that describe the color's saturation and its position on a color wheel. Specific embodiments of processes described here take as input the color metadata from the HDR10+ that is created using original source HDR content, with fixed hue boundaries and variable/dynamic saturation boundaries and tone-mapped HDR content.

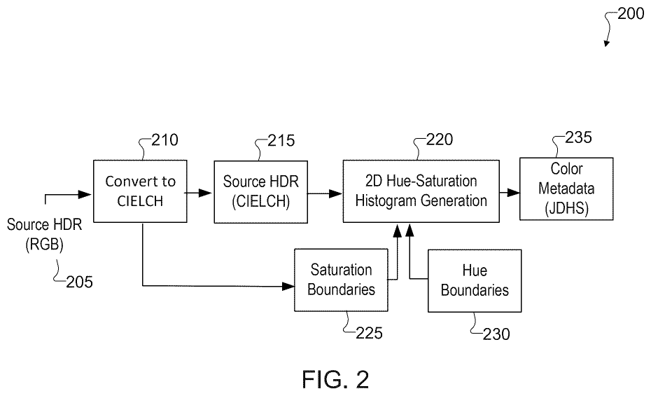

FIG. 2 illustrates an example process 200 for constructing color metadata according to this disclosure. For ease of explanation, the process 200 is described as being implemented using one or more components of the electronic device 101 described above. However, this is merely one example, and the process 200 could be implemented using any other suitable device(s), such as the server 106.

As shown in FIG. 2, the electronic device 101 obtains source HDR content 205 as an input to the process 200. In some cases, the source HDR content 205 could be in the RGB color space. Note that “obtains” (and its derivatives) can include loading from storage, receiving from another device or process (wired or wirelessly), or otherwise. Depending on the implementation, the source HDR content 205 could be captured by the electronic device 101 (such as by using at least one image sensor 180), retrieved from the memory 130, received from another electronic device (such as over the network 162), or obtained in any other suitable manner. This is one way in which various embodiments receive 2D hue-saturation color metadata corresponding to HDR source content. While specific embodiments use 2D hue-saturation color metadata, other embodiments can use metadata having three or more dimensions.

If needed, the electronic device 101 performs an RGB-to-CIELCH conversion operation 210 to convert the source HDR content 205 in the RGB color space to source HDR content 215 in the CIELCH color space. In some cases, the conversion operation 210 can include converting a source RGB image to the CIELCH color space and extracting the saturation channel. As a particular example, the conversion operation 210 can include constructing a cumulative distribution function (CDF) curve over the saturation channel of the image based on data points within the CIELCH color space. Here, the conversion operation 210 can include, based on the number of saturation divisions, extracting the corresponding saturation values from the CDF curve such that each saturation range has the same number of pixels to define dynamic saturation boundaries 225. Of course, if the received source HDR content 205 is already in the CIELCH color space, at least some portions of the conversion operation 210 may be unnecessary. In such cases, the electronic device 101 may only need to extract the saturation channel, construct the CDF curve, and extract the saturation values as described.

The electronic device 101 performs a 2D hue-saturation histogram generation operation 220 (“generating color metadata”) to produce dynamic color metadata 235 (also referred to as Joint Distribution of Hue and Saturation or “JDHS”). In some cases, the dynamic color metadata 235 can be in the form of a 2D hue-saturation histogram and may be considered as a saturation enhancing model. In some embodiments, the 2D hue-saturation histogram generation operation 220 can use the fixed hue quantization boundary divisions 230 from the source HDR content as well as the extracted dynamic saturation boundaries 225. In particular embodiments, the 2D hue-saturation histogram generation operation 220 can include initializing a matrix ([H, S]—color metadata) of size (6,5) for hue and saturation, respectively. The 2D hue-saturation histogram generation operation 220 can include, based on the pixels in the ranges of the fixed hue quantization boundary divisions 230 and the extracted dynamic saturation boundaries 225, updating the counts of the metadata and normalizing the metadata over the saturation axis for each hue range. Here, the 2D hue-saturation histogram can be considered a saturation enhancing model based on the 2D hue-saturation color metadata.

As described below, the scene-adaptive color enhancing process can be configured to use the 2D hue-saturation color metadata based on the CDF curves in the saturation dimension. The 2D hue-saturation color metadata can include a histogram generated from the HDR source content with fixed hue quantization boundaries and dynamically-determined saturation boundaries.

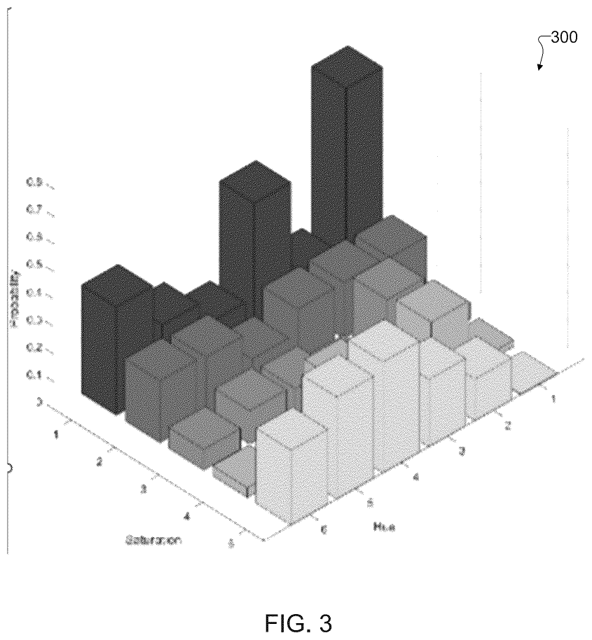

FIG. 3 illustrates an example color metadata 300 represented as a normalized histogram with counts/probability of each division of saturation and hue in accordance with this disclosure. The process described with respect to FIG. 2 provides a mechanism for HDR content creation with dynamic color metadata. This process can be performed at any time to produce dynamic color metadata corresponding to HDR source content. After the dynamic color metadata is created, the dynamic color metadata can be stored, transmitted, retrieved, encoded, packed, and/or broadcast with the HDR source content. This allows the dynamic color metadata and the HDR source content to be used together to produce enhanced HDR color content for display on at least one display device as described in more detail below.

The process described with respect to FIG. 2 is one way in which various embodiments perform a scene-adaptive color enhancing process to build a saturation enhancing model based on 2D hue-saturation color metadata. As described, the scene-adaptive color enhancing process includes generating one or more CDF curves in a saturation dimension based on the 2D hue-saturation color metadata.

Although FIG. 2 illustrates one example of a process 200 for constructing color metadata, various changes may be made to FIG. 2. For example, various functions in FIG. 2 may be combined, further subdivided, replicated, omitted, or rearranged and additional components or functions may be added according to particular needs. Although FIG. 3 illustrates one example of color metadata 300 represented as a normalized histogram with counts/probability of each division of saturation and hue, various changes may be made to FIG. 3. For instance, the contents of the color metadata 300 are examples only and can vary depending on the circumstances.

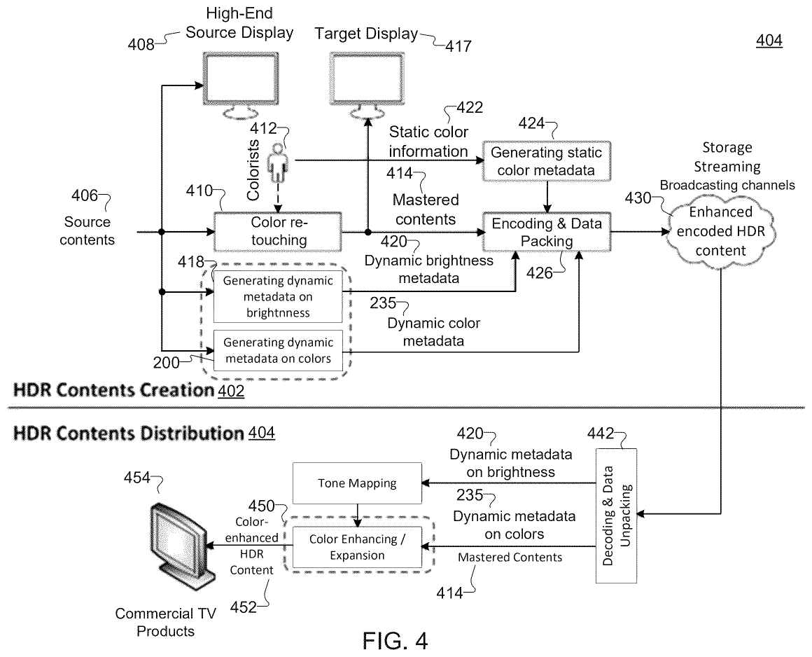

FIG. 4 illustrates an example of processing-intensive HDR content creation 402 with dynamic color metadata in accordance with this disclosure. The HDR content creation 402 can be performed along with computationally-cheaper HDR content distribution and display 404, which can include decoding and display of the enhanced HDR content. For ease of explanation, the HDR content creation 402 is described as being implemented using one or more components of the electronic device 101 described above. However, this is merely one example, and the HDR content creation 402 could be implemented using any other suitable device(s), such as the server 106.

As shown in FIG. 4, during the HDR content creation 402, a number of processes may be performed on source contents 406. These can include simply displaying the source contents 406 via a high-end source display 408 or a manual color retouching function 410 used by one or more colorists 412 to produce static color information 422 and mastered contents 414, which may be customized for and displayed on a target display 416. These processes can include generating static color metadata 424 from the static color information 422. These processes can also include generating dynamic metadata 418 on the brightness of the source contents 406 to produce dynamic brightness metadata 420. In accordance with disclosed embodiments, the HDR content creation 402 can include the process 200 as described above for generating dynamic metadata on colors to produce dynamic color metadata 235.

In this example, the mastered contents 414, along with dynamic color metadata 235, can be encoded and packed 426 to produce enhanced encoded HDR content 430. In various embodiments, the encoding and packing operation can also process static color metadata 424 and dynamic brightness metadata 420. The resulting enhanced encoded HDR content can be sent to a storage for later retrieval, streamed to at least one receiving electronic device, or broadcast for reception by at least one receiving electronic device. In specific cases, on a single electronic device 101, once the HDR content creation 402 is performed by a digital signal processor, enhanced encoded HDR content 430 and/or dynamic color metadata can be stored in a local storage on the electronic device 101. The HDR content distribution and display 404 described below can be performed using an energy-efficient and less-expensive chipset, such as a system-on-a-chip (SOC).

Because the HDR content creation 402 can be performed as a “pre-processing” stage, offline from the HDR content distribution and display 404, the compute-intensive processing need only be performed once for any given HDR source content to be able to distribute, decode, and display the enhanced encoded HDR content 430 as described here. For the example of FIG. 4, the HDR content distribution and display 404 can be performed in real-time using fewer computational resources, meaning that less expensive, faster, and more energy-efficient processors 120 can be used (e.g., optionally in a separate electronic device 101). This provides distinct technical advantages by enabling display of enhanced HDR color images more efficiently in terms of compute power, speed, and energy use by leveraging the enhanced encoded HDR content 430 that includes the dynamic color metadata 235.

In this example, the HDR content distribution and display 404 receives enhanced encoded HDR content 430 that includes the dynamic color metadata 235. The electronic device 101 (which can be a separate electronic device 101 than the one that performed the HDR content creation 402) can perform a decoding and data unpacking operation 442, which can produce dynamic brightness metadata 420 (if it was encoded/packed). The operation 442 can produce the dynamic color metadata 235 and the unpacked mastered contents 414.

The dynamic brightness metadata 420 can be used for tone mapping 446 to produce tone-mapped HDR frames. In accordance with disclosed embodiments and as described in more detail here, the dynamic color metadata 235 can be used for a color enhancing/expansion operation 450 that applies the dynamic color metadata 235 to the mastered contents 414. The tone-mapped HDR frames from the tone mapping 446 can be used to produce color-enhanced HDR content 452 for display on an electronic device 454, such as a commercial TV product or other electronic device. In some cases, the electronic device 454 can be implemented by the same electronic device 101 used to decode, unpack, and enhance the HDR content.

Although FIG. 4 illustrates one example of processing-intensive HDR content creation 402 with dynamic color metadata, various changes may be made to FIG. 4. For example, various functions in FIG. 4 may be combined, further subdivided, replicated, omitted, or rearranged and additional components or functions may be added according to particular needs.

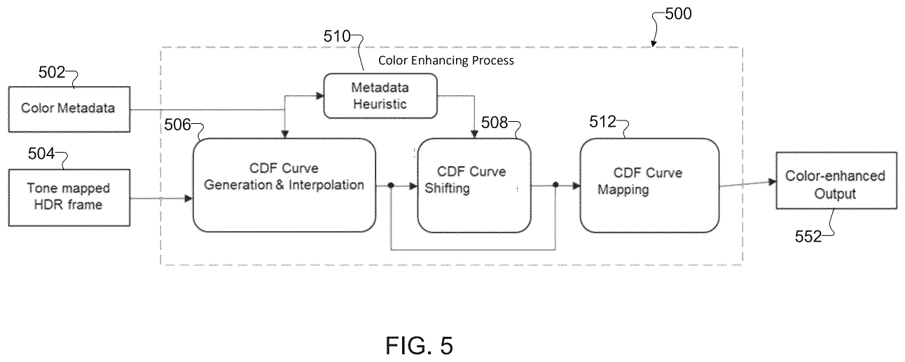

FIG. 5 illustrates an example process 500 for a color enhancing/expansion to produce color-enhanced HDR content according to this disclosure. For ease of explanation, the process 500 is described as being implemented using one or more components of the electronic device 101 described above. However, this is merely one example, and the process 500 could be implemented using any other suitable device(s), such as the server 106. As a particular example, the process 500 may be performed on the electronic device 454, such as a commercial TV product or other electronic device, implemented as the electronic device 101.

As shown in FIG. 5, inputs to the process 500 include dynamic color metadata 502 with hue and saturation boundaries as disclosed here, such as the dynamic color metadata 235. The dynamic color metadata 502 may be extracted in the form of a 2D histogram, which could be normalized along the saturation dimension for all hue values. The dynamic color metadata 502 including the hue and saturation division boundaries can be provided as input to the process 500. As described, in various embodiments, the fixed hue quantization boundaries can include six hue ranges, and the dynamically-determined saturation boundaries can include five saturation divisions.

Inputs to the process 500 also include tone-mapped HDR frames 504, such as the tone-mapped HDR frames from the tone mapping 446. After applying tone mapping on the input source HDR, the tone-mapped output, which can be in the form of tone-mapped HDR frames, can be used as input to the color enhancing process 500. If necessary, the electronic device 101 can convert the tone-mapped data from the RGB color space to the CIELCH color space and separate chroma and luminance channels. In some cases, this can be used for computation on the saturation and hue channels. The output of the process 500 includes color-enhanced HDR output 552, which can be converted back to the RGB color space. In color-enhanced HDR data, in some embodiments, only the saturation channel is updated while keeping the others constant. Color-enhanced HDR data can be displayed, such as on a commercial TV product or other electronic device implemented as an electronic device 101.

In the process 500, the electronic device 101 performs a CDF curve generation and interpolation process 506. The input of the CDF curve generation and interpolation process 506 can include the tone-mapped HDR frames 504 and the dynamic color metadata 502 in the CIELCH color space, which can include the normalized 2D histogram metadata, JDHS. The CDF curve generation and interpolation process 506 outputs a CDF-based matrix, C_{f}, that is inputted into the next process. The CDF curve generation and interpolation process 506 is used to compute the CDF curves from the dynamic color metadata 502. In some cases, this can be divided into sub-processes for ease of understanding.

For CDF curve generation, the CDF curve generation and interpolation process 506 can include creating CDF curves for all six hue ranges over the saturation dimension, Cₕₛ, based on the input normalized histogram metadata, JDHS, such as by cumulative addition along the saturation dimension. This process 506 can also include adding midpoints of the current saturation ranges as extra controls points, S, in the saturation dimension and interpolating to extract the CDF values at those points. These values can be combined with the JDHS to create a new CDF matrix, C′ₕₛ. Since CDF curves are available for certain fixed hue ranges, in various embodiments, the electronic device 101 can interpolate the current metadata, C′ₕₛ, to a broader range of hue values to maintain continuity. In this way, various embodiments can generate CDF curves along a saturation dimension from the 2D hue-saturation color metadata.

For CDF curve interpolation, the CDF curve generation and interpolation process 506 can include extracting unique hue values from the tone-mapped input and rounding them (such as to one decimal point) h_{f}. This process 506 can also include determining the newly-extracted hue values, h_{f}, using linear interpolation based on a 2D gridded input, C′ₕₛ, to output a CDF-based matrix C_{f}. This process is one way in which disclosed embodiments can perform hue interpolation based on the saturation enhancing model to preserve color hue accuracy while enhancing saturation. In various embodiments, this process can include interpolating an augmented CDF matrix in two dimensions to obtain CDF values for a plurality of hue values extracted from the HDR source content. The CDF curve generation and interpolation process 506 can output the CDF-based matrix C_{f} to a CDF curve shifting process 508 and to a CDF curve mapping process 512.

The CDF curve shifting process 508 takes the previously-generated CDF curves C_{f} and the saturation control points S. Along with these, the CDF curve shifting process 508 may also receive input shifting parameters that decide the amount of shifts, s_x, whose value could be generated by a metadata heuristic process 510, and could be based on the sparsity of the metadata, while the other parameter s_y could be fixed (such as at 0.5). Using the interpolated CDF values from the CDF curve generation and interpolation process 506, the CDF curve shifting process 508 can shift the curve by horizontally shifting the (x-axis) saturation control points and also vertically shifting the CDF values to create a new shifted CDF matrix, C_{f}′. In some cases, the CDF curve shifting process 508 can calculate the slopes of the CDF curves based on the x-ranges and γ-ranges. The slope values serve as a guide to shift the curve accordingly. The CDF curve shifting process 508 can also assign different degrees of shifting based on the slope values, such as by linear interpolation. In example embodiments, the CDF curve shifting process 508 may operate based on the following.
slope_guide_x=[min(slopes), 0.25*mean(slopes), max(slopes)]
slope_guide_y=[min(slopes), mean(slopes), max(slopes)]
shift_guide_x=[1,1+0.85*(s_x−1), s_x]
shift_guide_y=[0, 0.5*s_y, s_y]

For horizontal shifting of the input saturation control points, S, the CDF curve shifting process 508 can incrementally add the x-ranges based on shift_guide_x to get the shifted control points, S′. For vertical shifting of the CDF values of the input C_{f}, CDF curve shifting process 508 can decrease the existing C_{f} by an amount that is equal to the product of the y-range and its corresponding shift_guide_y to output the shifted CDF, C_{f}′. In this way, in various embodiments, the electronic device 101 can shift the CDF curves by applying a horizontal shift to saturation control points and a vertical shift to CDF values to produce shifted CDF curves, where the horizontal shift is based on slope values of the CDF curves across saturation ranges and the vertical shift is based on a fraction of a CDF value range.

For each of the extracted unique hue values h_{f} from the previous function, the CDF curve mapping process 512 extracts the saturation values, s, from the tone-mapped input that lie in the corresponding hue range. For example, the CDF curve mapping process 512 can extract the CDF values from C_{f} and the shifted CDF matrix, C_{f}′. The CDF curve mapping process 512 can also interpolate the saturation values, s, with respect to the CDF matrix C_{f} to output the CDF values, y_S. For each of the extracted CDF values, y_S, the CDF curve mapping process 512 can query the shifted CDF, C_{f}′ using interpolation, resulting in improved saturation values, s′. Here, the CDF curve mapping process 512 can update the extracted old saturation values with the new saturation values and convert the updated content (the color enhanced HDR output 552), such as from the CIELCH color space to the RGB color space, for further display services. Various embodiments here can generate, based on the HDR source content and the hue interpolation, output image data corresponding to the HDR source content and having enhanced color content.

The metadata heuristic process 510 estimates the shifting parameters for the CDF curves and can be adaptive with respect to the input data. For example, the metadata heuristic process 510 can be conditioned on the metadata and its properties as described here. In some cases, two conditions can be defined to compute a shift value based on the metadata. One of the conditions can be based on the sparsity of the metadata, while the other can be based on the variance across different hue ranges. In some embodiments, the metadata heuristic process 510 can interact with the CDF curve generation and interpolation process 506 and the CDF curve shifting process 508.

Although FIG. 5 illustrates one example of a process 500 for a color enhancing/expansion to produce color-enhanced HDR content, various changes may be made to FIG. 5. For example, various functions in FIG. 5 may be combined, further subdivided, replicated, omitted, or rearranged and additional components or functions may be added according to particular needs.

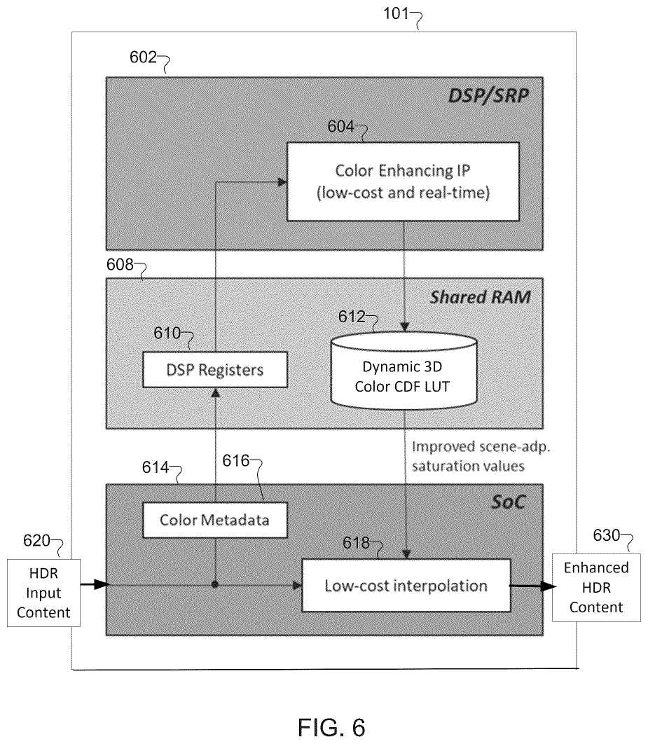

FIG. 6 illustrates a specific example implementation of an electronic device 101 having a digital signal processor (DSP) 602, shared random access memory (RAM) 608, and system-on-a-chip (SOC) 614 in accordance with this disclosure. For ease of explanation, in the context of FIG. 1, both the DSP 602 and the SOC 614 can be implemented as the processor 120, although those of skill in the art will recognize that a DSP is typically much more powerful, expensive, and energy-hungry compared to an SOC. In some cases, the DSP 602 can be implemented using a SAMSUNG Reconfigurable Processor (SRP) manufactured by SAMSUNG ELECTRONICS CO., LTD.

In this example, the HDR content creation 402 as shown in FIG. 4 can be implemented by the DSP 602 as color enhancing image processing (IP) 604, which can output a shifted CDF matrix in the form of a dynamic 3D color CDF lookup table (LUT) 612. Similarly, the HDR content distribution and display 404 as shown in FIG. 4 can be implemented by the SOC 614 as low-cost interpolation 618, which can read the shifted CDF matrix and/or other data from the dynamic 3D color CDF LUT 612. In some cases, this data can include improved scene-adaptation saturation values. The SOC 614 can receive the color metadata 616, separately or as part of the HDR content, for use in the low-cost interpolation 618 and can store the color metadata 616 in DSP registers 610 of shared RAM 608 for use with the color enhancing IP 604 performed by the DSP 602. This is one way in which the scene-adaptive color enhancing processes as disclosed here can dynamically shift one or more CDF curves in the saturation dimension in accordance with one or more scene-adaptive LUTs. In some cases, the color metadata 616 stored in the DSP registers 610 can be used by the color enhancing image processing (IP) 604 to update the 3D color CDF LUT 612 with luma information. While specific embodiments use a 3D color CDF LUT, other embodiments can use a LUT with two dimensions or a greater number of dimensions.

The SOC 614 operates on the input HDR content 620 (from which the color metadata 616 is extracted), decodes the color metadata 616, and sends the decoded color metadata 616 to the DSP 602 via the DSP registers 610. After the computations performed by the DSP 602, the SOC 614 uses the dynamic 3D color CDF LUT 612 present in the shared RAM 608 to compute a low-cost interpolation 618 in order to output color-enhanced HDR content 630.

In this way, in various embodiments, the SOC 614 can perform hue interpolation based on the saturation enhancing model to preserve color hue accuracy while enhancing saturation. The SOC 614 can also generate, based on the HDR source content and the hue interpolation, output image data corresponding to the HDR source content and having enhanced color content. The scene-adaptive color enhancing process can be configured to use the 2D hue-saturation color metadata based on the one or more CDF curves in the saturation dimension.

Although FIG. 6 illustrates one specific example implementation of an electronic device 101 having a DSP 602, shared RAM 608, and SOC 614, various changes may be made to FIG. 6. For example, various functions in FIG. 6 may be combined, further subdivided, replicated, omitted, or rearranged and additional components or functions may be added according to particular needs.

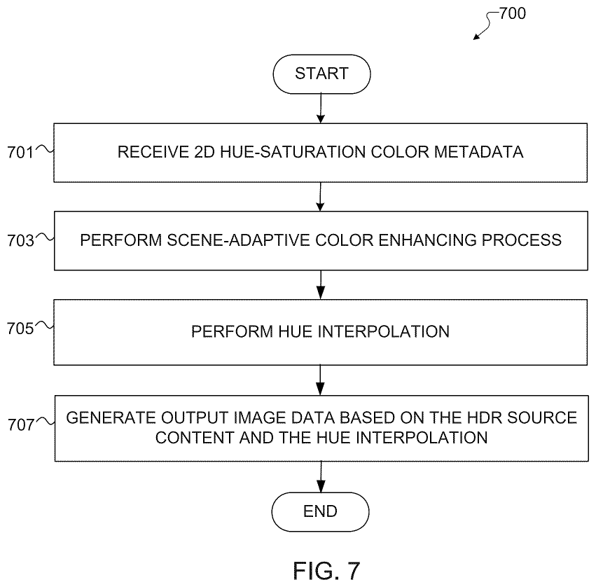

FIG. 7 illustrates an example method 700 for producing image data according to this disclosure. For ease of explanation, the method 700 shown in FIG. 7 is described as involving the use of the electronic device 101 shown in FIG. 1 and one or more of the processes and architectures shown in FIGS. 2 through 6. However, the method 700 shown in FIG. 7 could be used with any other suitable device(s) in any other suitable system(s) and with any other suitable process(es) and architecture(s).

As shown in FIG. 7, receiving 2D hue-saturation color metadata corresponding to HDR source content is performed at step 701. This could include, for example, the processor 120 of the electronic device 101 receiving the color metadata and performing the other processes described above. Configuring a scene-adaptive color enhancing process to build a saturation enhancing model based on the 2D hue-saturation color metadata is performed at step 703. In various embodiments, the scene-adaptive color enhancing process includes generating one or more cumulative distribution curves in a saturation dimension based on the 2D hue-saturation color metadata; and dynamically shifting the one or more cumulative distribution curves in the saturation dimension in accordance with one or more scene-adaptive LUTs. In some embodiments, the scene-adaptive color enhancing process is configured to use the 2D hue-saturation color metadata based on the one or more cumulative distribution curves in the saturation dimension.

According to disclosed embodiments, the 2D hue-saturation color metadata may include a histogram generated from the HDR source content with fixed hue quantization boundaries and dynamically-determined saturation boundaries. In various implementations, the fixed hue quantization boundaries comprise six hue ranges, and/or the dynamically-determined saturation boundaries comprise five saturation divisions. Also, in various embodiments, configuring the scene-adaptive color enhancing process includes generating CDF curves along a saturation dimension from the 2D hue-saturation color metadata.

Performing hue interpolation, based on the saturation enhancing model, to preserve color hue accuracy while enhancing saturation is performed at step 705. In various embodiments, performing the hue interpolation includes interpolating, for a plurality of hue values extracted from the HDR source content, an augmented CDF matrix in two dimensions to obtain CDF values for the plurality of hue values. Generating output image data corresponding to the HDR source content and having enhanced color content, based on the HDR source content and the hue interpolation, is performed at step 707.

Although FIG. 7 illustrates one example of a method 700 for color enhancement in HDR imagery, various changes may be made to FIG. 7. For example, while shown as a series of steps, various steps could overlap, occur in parallel, occur in a different order, or occur any number of times.

Various embodiments can also include a scene-adaptive color enhancing algorithm that directly builds the saturation enhancing model based on the 2D hue-saturation color metadata. Disclosed embodiments include processes in which the 2D hue-saturation color metadata is generated from the source HDR contents. For example, disclosed embodiments can efficiently use the input 2D color metadata by generating cumulative distribution (CD) curves in the saturation dimension and further elaborate on enhancing the saturation from shifting the CD curves. Disclosed embodiments can employ hue interpolation processes to preserve color hue accuracy while enhancing the saturation. The saturation improving operations can be conducted by dynamically shifting the cumulative curves of the saturation. Among other things, disclosed embodiments simplify hardware implementations by utilizing scene-adaptive LUTs, and hardware costs and energy usage can be reduced significantly. Television products, for example, can apply the disclosed adaptive color enhancing processes based on dynamic color metadata to recover more visual quality of original HDR content.

In addition to the techniques described above using color metadata and a shifted CDF matrix, other disclosed embodiments address techniques for achieving hue-invariant and content-adaptive color enhancing/expansion for improved images on televisions and other devices. To obtain high-quality colors, color processing can follow the vision properties of human vision system (HVS) and not generate visible hue distortions. Current color image processing techniques generally use massive nonlinear processing that includes complex operators, such as exponential, log, or triangle operators, so that they are difficult or impossible to implement in commercial products that may require relatively-low costs.

Disclosed embodiments also include high-performance color enhancing processes that are hardware-friendly. Since color processing can involve pixel-wise processing and can generally be implemented in chipsets, once a color image processing system is embedded into a chipset, it typically cannot be changed until the next chipset update. This is also a big constraint of adopting some color enhancing approaches. Disclosed embodiments overcome these disadvantages and solve the problem of high costs in hardware implementations of high-performance color enhancing algorithms. For example, disclosed systems and methods can implement high-cost and time-consuming color processing logic in DSP, which can be updated in software, with very low costs in hardware. In some embodiments, the disclosed technology can include an architecture that enables complicated color processing logic to be performed in DSP only with a low-cost interpolation embedded in an SOC. This provides a significant technical advantage over other systems in which color processing logic is generally carried out in the SOC, which greatly increases production costs and is less efficient computationally and with respect to energy usage.

In some cases, disclosed embodiments can dynamically update a 3D LUT in DSP with high-performance hue fidelity image processing so that an SOC chipset only has to carry out simple pixel-wise processing (such as interpolation) to obtain high quality colors. As new image processing techniques are developed, existing products in the market can use them without waiting for a chipset update. Further, processing in various embodiments can be separated into off-device and on-device processing for complicated color processing algorithms. In these cases, off-device processing can perform the expensive and time-consuming processing portions of color image processing, while on-device processing can perform the low-cost and real-time processing portions of color image processing. Disclosed embodiments could dynamically update 3D color LUTs in DSP only, thus pixel-wise color image processing can be implemented only in economic DSPs without any color-related processing in expensive SOCs. This is a significant technical advantage over systems that use static LUTs, which do not allow scene-wise or frame-wise updates.

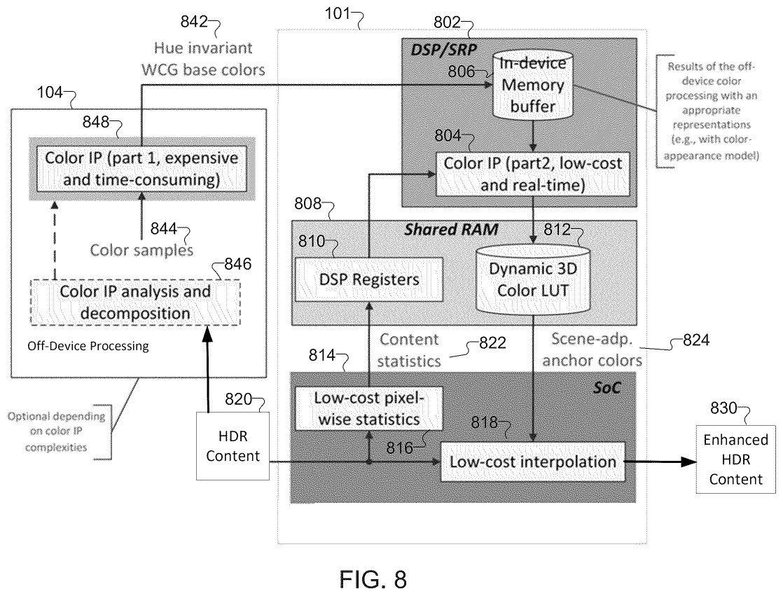

FIG. 8 illustrates another specific example implementation of an electronic device 101 having a DSP 802, shared RAM 808, and SOC 814 in accordance with this disclosure. For ease of illustration, in the context of FIG. 1, both the DSP 802 and the SOC 814 can be implemented as the processor 120, although those of skill in the art will recognize that a DSP is typically much more powerful, expensive, and energy-hungry compared to an SOC. In some cases, the DSP 802 can be implemented using an SRP.

In this example, the processes shown as performed by the electronic device 101 can be performed in real-time to convert high dynamic range (HDR) content 820, which may have a narrow color gamut (NCG), into HDR content 830, which has enhanced colors and may have a wider color gamut (WCG). In some embodiments, the same HDR content 820 can be pre-processed using off-device processing on a second electronic device 104 as described below to produce hue-invariant WCG base colors 842, which can be stored in an in-device memory buffer 806. Note that, as used here, “narrower color gamut” can be used to describe NCG content, where “narrow” or “narrower” is relative to the “wide” or “wider” color gamut referred to as WCG content. While certain standards, such as DCI-P3 created by the Digital Cinema Initiatives and BT.709 and BT2020 created by the International Telecommunication Union, may in specific use cases each refer to a narrower or wider color gamut, the techniques disclosed herein can refer to any HDR content whose color properties are enhanced and whose color gamut may be widened in a relative sense.

As illustrated in FIG. 8, these approaches can implement high-performance but expensive color enhancing/expansion, such as hue-invariant and content-adaptive processing, with very low costs, providing a distinct technical advantage over other systems. Furthermore, in some embodiments of the disclosed technology, new color image processing devices can be quickly updated for products that are already in the market without waiting for next chipset updating. In this example, off-device processing is performed by an electronic device 104 (or multiple other electronic devices). The other electronic device 104 can receive the HDR content 820 and perform color image processing analysis and decomposition processes 846 to analyze the HDR content 820. The electronic device 104 also can perform more computationally intense, energy-consuming, and time-consuming image processing tasks 848 using the analysis of the HDR content 820 and color samples 844 to produce hue-invariant WCG base colors 842 that correspond to the HDR content 820. The hue-invariant WCG base colors 842 can be stored in the in-device memory buffer 806 of the DSP 802 of the electronic device 101 (or read by the DSP 802 of the electronic device 101 to be stored in the in-device memory buffer 806).

The off-device processes can include any computationally expensive and time-consuming processing of the color image processing to generate one or more base datasets, which can be considered as the semi-finished anchor colors. By using the output of the off-device processing in the electronic device 101, the electronic device 101 can perform in-device processing to produce substantially the same enhanced/extended colors as other systems may produce but using with very low-cost hardware, much less energy, and less compute power.

In this example, the electronic device 101 performs one or more in-device processes using the DSP 802. The DSP 802 carries out the remaining parts of color image processing that are not processed in the off-device processing based on the semi-finished color datasets, including the hue-invariant WCG base colors 842, and dynamically updates one or more 3D color LUTs 812 for pixel-wise interpolation in the SOC 814. The image processing tasks performed by the DSP 802 can also use content statistics 822 produced by the SOC 814 and stored in DSP registers 810 of the shared RAM 808 and can store scene-adapted anchor colors 824 in the 3D color LUTs 812. Since the high-cost portions of the color image processing can be done in the off-device processing by the electronic device 104, only low-cost DSP processing may be necessary in the electronic device 101.

In some cases, dynamically updating a 3D LUT in digital signal processing can include hue fidelity processing and can be based on narrow color gamut image data such as the HDR content 820. Dynamically updating the 3D LUT can include updating the 3D LUT on a frame-wise basis using scene statistics determined from the low-dynamic-range image data. Dynamically updating the 3D LUT can also or alternatively include updating the 3D LUT on a scene-wise basis responsive to detection of scene changes in the low-dynamic range image data. In some embodiments, dynamically updating the 3D LUT can include generating a set of scene-adapted anchor colors 824 based on off-device processing and updating the 3D LUT by the DSP using a set of anchor colors. In various embodiments, the off-device processing performed, for example, by the electronic device 104 includes executing one or more computationally-expensive nonlinear operators, such as at least one of an exponential function, a logarithmic function, or a trigonometric function, to generate the set of anchor colors. In some cases, dynamically updating the 3D LUT includes adapting one or more saturation expansion parameters based on one or more statistics including at least one of chroma histogram features, average saturation, scene contrast, or luminance percentile measures. In some embodiments, the DSP 802 can also maintain an input hue quality as perceived by a human vision system (HVS) based on the hue fidelity processing. The hue fidelity processing can include enforcing hue-invariant mapping in a perceptual color space so as to reduce visible hue distortions as perceived by the HVS.

The SOC 814 can perform simple and very low-cost interpolation-based in-device processing to perform such tasks as processing the HDR content 820 to analyze low-cost pixel-wise statistics 816 and store these and other content statistics 822 in the DSP registers 810 of the shared RAM 808. Based on the HDR content 820 and the data retrieved from the 3D color LUTs 812, such as the scene-adapted anchor colors 824, the SOC 814 can efficiently perform low-cost interpolation 818 and produce the HDR content 830 for display on the electronic device 101 or another device. Such interpolation, in some embodiments, has no relationship with specific color processing but can include common processing tasks performed by any chipset. This is one way in which various embodiments can performing pixel-wise processing of the low-dynamic range image data to produce high-dynamic range image data having a wider color gamut. In some embodiments, the pixel-wise processing can include interpolation 818 and other processes. In particular embodiments, performing the pixel-wise processing includes performing gamut mapping that constrains output colors to a target color gamut while preserving hue and minimizing clipping artifacts. In various embodiments, the interpolation for the pixel-wise processing is performed only by the chipset, such as the SOC 814, and the hue fidelity processing and 3D LUT updates are performed exclusively in the DSP device, such as the DSP 802.

As can be seen, high-performance but expensive color image processing can be substantially or entirely implemented in the DSP 802 without any changes in the SOC 814 once interpolation processes are embedded into the SOC 814. Since color processing can be performed pixel-wise, disclosed techniques overcome problems and inefficiencies of other systems. For example, other systems typically implement color image processing in a chipset, which is very expensive and cannot be easily updated when new color image processing techniques become available. Also, other systems may pre-compute static color data for pixel-wise processing in the chipset, but this cannot adaptively obtain optimized colors for different scenes due to static color data, which remains constant as scene contents change. Disclosed embodiments provide advantages over these other approaches by dynamically updating 3D color LUTs based on semi-finished color datasets and with scene properties to obtain high-quality content-adaptive enhanced/extended colors with very low costs. Systems as disclosed here can implement high-performance but very expensive color image processing with very low hardware costs, nearing zero cost once interpolation is embedded in the SOC 814.

Although FIG. 8 illustrates another specific example implementation of an electronic device 101 having a DSP 802, shared RAM 808, and SOC 814, various changes may be made to FIG. 8. For example, various functions in FIG. 8 may be combined, further subdivided, replicated, omitted, or rearranged and additional components or functions may be added according to particular needs.

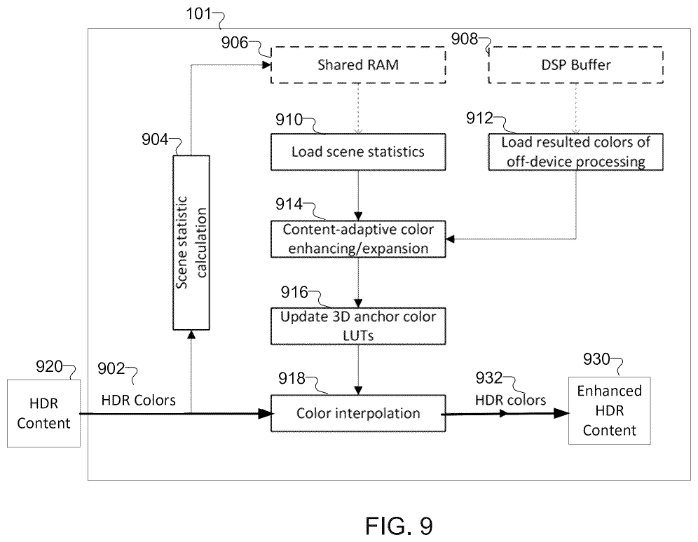

FIG. 9 illustrates example processes that can be performed by an electronic device 101 in accordance with this disclosure. For ease of explanation, these are described as being implemented using one or more components of the electronic device 101 described above. However, this is merely one example, and the processes could be implemented using any other suitable device(s), such as the server 106.

As shown in FIG. 9, the electronic device 101 can receive HDR content 920, which may have a narrow color gamut, that includes HDR colors 902. The electronic device 101 performs scene statistic calculations 904 to store content statistics in a shared RAM 906. The electronic device 101 loads the content statistics and other scene statistics at 901 from the shared RAM 906 and uses these statistics to perform content-adaptive color enhancing and expansion 914. Content-adaptive color enhancing and expansion 914 can also load, from a DSP buffer 908, and use any color data 912 from off-device processing. After the content-adaptive color enhancing and expansion 914, the electronic device 101 can update 3D color LUTs 916. Using the HDR colors 902 and the data from the 3D color LUTs, the electronic device 101 can perform color interpretation to produce enhanced HDR content 930, which has enhanced colors and may have a wider color gamut, including HDR colors 932.

Although FIG. 9 illustrates examples of processes that can be performed by an electronic device 101, various changes may be made to FIG. 9. For example, various functions in FIG. 9 may be combined, further subdivided, replicated, omitted, or rearranged and additional components or functions may be added according to particular needs.

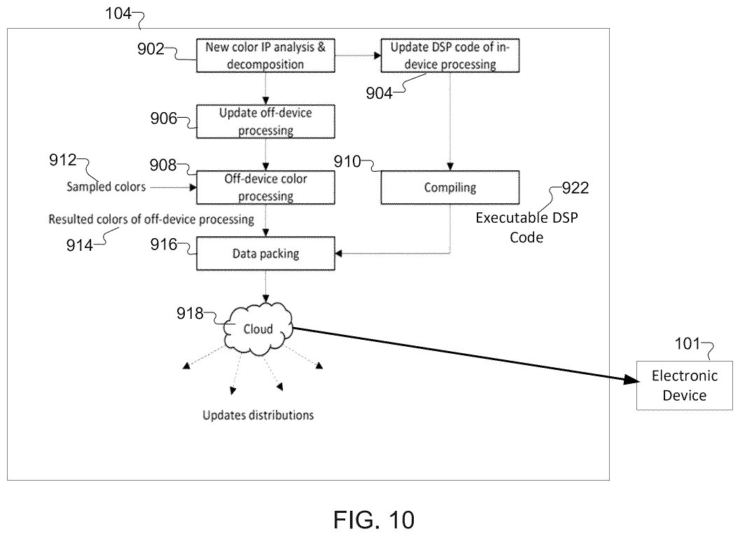

FIG. 10 illustrates other example processes that can be performed by an electronic device 104 in accordance with this disclosure. More specifically, FIG. 10 illustrates offline or off-device processes as disclosed here that can be performed by the electronic device 104 to provide the color data for one or more electronic devices. For ease of explanation, these are described as being implemented using one or more components of the electronic device 104 described above. However, this is merely one example, and the processes could be implemented using any other suitable device(s), such as the server 106.

As shown in FIG. 10, the electronic device 104 can implement new color image processing and decomposition processes 1002 (such as executable instructions). If the new color image processing and decomposition processes 1002 includes DSP code to be executed on an electronic device 101, the electronic device 104 can compile this DSP code at operation 1010 to produce executable DSP code 1022. Based on the new color image processing and decomposition processes 1002, the electronic device 104 can update its own off-device processing at operation 1006.

During execution of the executable DSP code 1022, the electronic device 104 receives sampled colors 1012, such as in the HDR content 820, and performs the off-device color processing 1008 to produce resulted colors 1014, such as hue-invariant WCG colors 842. The electronic device 104 can also perform data packing 1016 to pack the resulted colors 1014, and any executable DSP code 1022, into a distributable package that can be transmitted to one or more electronic devices 101, such as via a cloud 1018 or other network 162. The electronic device 101 can unpack this distributable package to update its own DSP programming, if necessary, and perform any image processing tasks as disclosed here. Note that the techniques disclosed here can be used with any suitable electronic device 101, including but not limited to HDR and WCG TV products, high-end display systems, and displays of mobile devices.

Disclosed embodiments significantly improve on other approaches. For example, disclosed embodiments can use a high-performance perceptual hue-preserved color enhancing algorithm (which may be referred to dynamic and cognitive color enhancing and gamut expansion using 3D color models) to extend BT.709 HDR content to the DCI-P3 gamut, which is a wide color gamut. Disclosed embodiments can use a DSP and/or off-device processing to achieve expensive 3D perceptual hue fidelity color models and exploit the illusion effects of human vision system to get vivid but natural colors and provide skin-tone protection. These are tasks that are not typically suitable for SOC processing since they are computationally expensive and use many complex operators such as triangle functions, exponential computations, etc.

By using the disclosed techniques, complex processes are executed in the DSP and/or in a separate device 104. In this way, only the very low-cost linear interpolation operator may be needed in the SOC of the electronic device 101. In some cases, all complex and time-consuming processing can be performed off-device, and the results can be packed inside the semi-finished color dataset in a distributable package in the electronic device 104. Only the real-time and content-adaptive processing may be coded in the DSP of the electronic device 101. Using the disclosed techniques, if updates are available for the image processing programming, such as a new 3D hue preserving model becomes available, the semi-finished dataset can be regenerated in off-device processing, and the DSP of the electronic device 101 can be updated via a cloud service or otherwise without necessity of updating the SOC of the electronic device 101.

In some embodiments, the disclosed techniques provide an architecture and processes configured to enable complicated color processing logic to be carried out in DSP only with the low-cost interpolation embedded in SOC. Also, in some embodiments, the processes disclosed here can be decomposed into off-device and in-device processing for complicated color processing algorithms so that off-device processing carries out the expensive and time-consuming processing portions of color image processing and in-device processing carries out low-cost and real-time portions of the color image processing. In addition, the electronic device 101 can dynamically update 3D color LUTs in DSP only, thus pixel-wise color image processing can be implemented only in economic DSPs without any color-related processing in expensive SOCs.

Although FIG. 10 illustrates other examples of processes that can be performed by an electronic device 104, various changes may be made to FIG. 10. For example, various functions in FIG. 10 may be combined, further subdivided, replicated, omitted, or rearranged and additional components or functions may be added according to particular needs.

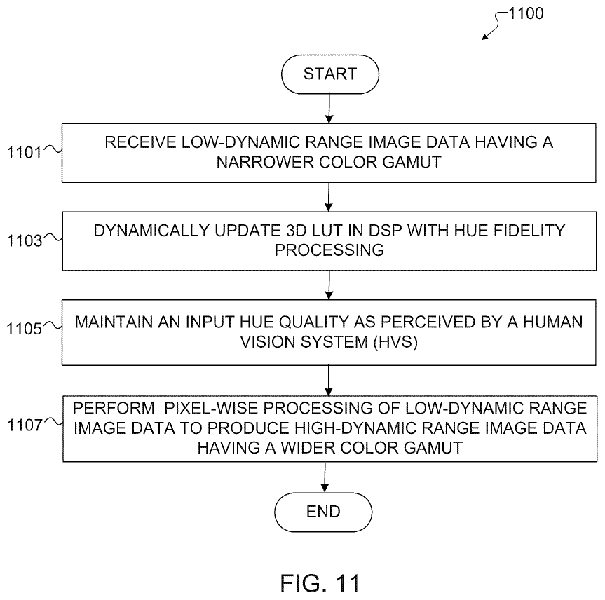

FIG. 11 illustrates an example method 1100 for producing image data according to this disclosure. For ease of explanation, the method 1100 shown in FIG. 11 is described as involving the use of the electronic device 101 and/or the electronic device 104 shown in FIG. 1 and one or more of the processes and architectures shown in FIGS. 8 through 10. However, the method 1100 shown in FIG. 11 could be used with any other suitable device(s) in any other suitable system(s) and with any other suitable process(es) and architecture(s).

As shown in FIG. 11, receiving LDR image data having a narrower color gamut is performed for an image at step 1101. This could include, for example, the electronic device 101 or the electronic device 104 receiving LDR image data. Dynamically updating a 3D LUT in digital signal processing with hue fidelity processing can be performed using at least one DSP device, based on the low-dynamic range image data, at step 1103. In some cases, the DSP device can be part of the electronic device 101 or the electronic device 104. In various embodiments, dynamically updating the 3D LUT includes updating the 3D LUT on a frame-wise basis using scene statistics determined from the low-dynamic-range image data. In various embodiments, dynamically updating the 3D LUT also or alternatively includes updating the 3D LUT on a scene-wise basis responsive to detection of scene changes in the low-dynamic range image data.

In some embodiments, dynamically updating the 3D LUT includes generating a set of anchor colors based on off-device processing and updating, in the digital signal processing device, the 3D LUT using the set of anchor colors. In various embodiments, the off-device processing may include executing one or more computationally-expensive nonlinear operators, such as at least one of an exponential function, a logarithmic function, or a trigonometric function, to generate the set of anchor colors. Also, in some embodiments, dynamically updating the 3D LUT includes adapting one or more saturation expansion parameters based on one or more statistics including at least one of chroma histogram features, average saturation, scene contrast, or luminance percentile measures.

Maintaining an input hue quality as perceived by a human vision system (HVS) using the DSP device and based on the hue fidelity processing is performed at step 1105. The hue fidelity processing can include enforcing hue-invariant mapping in a perceptual color space so as to reduce visible hue distortions as perceived by the HVS. Performing pixel-wise processing of the low-dynamic range image data to produce high-dynamic range image data having a wider color gamut is performed at step 1107. This can be performed, for example, by a chipset or SOC of the electronic device 101 or the electronic device 104. The pixel-wise processing could include interpolation. In some embodiments, performing the pixel-wise processing includes performing gamut mapping that constrains output colors to a target color gamut while preserving hue and minimizing clipping artifacts. In various embodiments, the interpolation for the pixel-wise processing is performed only by the chipset, and the hue fidelity processing and 3D LUT updates are performed exclusively in the DSP device. In various embodiments, one or more first higher-cost color-enhancing tasks are performed by a device other than the electronic device 101, such as by the electronic device 104, and one or more second higher-cost color-enhancing tasks are performed by the electronic device 101.

Although FIG. 11 illustrates one example of a method 1100 for producing image data, various changes may be made to FIG. 11. For example, while shown as a series of steps, various steps could overlap, occur in parallel, occur in a different order, or occur any number of times.

Any combination of the various features and operations discussed herein are within the abilities of one of skill in the art and are therefore within the scope of this disclosure.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
receiving, using at least one processing device of an electronic device, two-dimensional (2D) hue-saturation color metadata corresponding to high dynamic range (HDR) source content;
performing, using the at least one processing device, a scene-adaptive color enhancing process to build a saturation enhancing model based on the 2D hue-saturation color metadata;
performing, using the at least one processing device, hue interpolation, based on the saturation enhancing model, to preserve color hue accuracy while enhancing saturation; and
generating, using the at least one processing device and based on the HDR source content and the hue interpolation, output image data corresponding to the HDR source content and having enhanced color content.

2. The method of claim 1, wherein the scene-adaptive color enhancing process includes generating one or more cumulative distribution function (CDF) curves in a saturation dimension based on the 2D hue-saturation color metadata.

3. The method of claim 2, wherein the scene-adaptive color enhancing process further includes dynamically shifting the one or more CDF curves in the saturation dimension in accordance with one or more scene-adaptive lookup tables (LUTs).

4. The method of claim 2, wherein the scene-adaptive color enhancing process is configured to use the 2D hue-saturation color metadata based on the one or more CDF curves in the saturation dimension.

5. The method of claim 1, wherein the 2D hue-saturation color metadata comprises a histogram generated from the HDR source content with fixed hue quantization boundaries and dynamically-determined saturation boundaries.

6. The method of claim 5, wherein:
the fixed hue quantization boundaries comprise six hue ranges; and
the dynamically-determined saturation boundaries comprise five saturation divisions.

7. The method of claim 1, wherein performing the scene-adaptive color enhancing process comprises generating cumulative distribution function (CDF) curves along a saturation dimension from the 2D hue-saturation color metadata.

8. The method of claim 7, wherein performing the hue interpolation comprises interpolating, for a plurality of hue values extracted from the HDR source content, an augmented CDF matrix in two dimensions to obtain CDF values for the plurality of hue values.

9. The method of claim 7, further comprising:
shifting the CDF curves by applying a horizontal shift to saturation control points and a vertical shift to CDF values to produce shifted CDF curves;
wherein the horizontal shift is based on slope values of the CDF curves across saturation ranges; and
wherein the vertical shift is based on a fraction of a CDF value range.

10. The method of claim 1, wherein the saturation enhancing model is constructed to modify only a saturation channel while preserving a luminance channel and a hue channel of the HDR source content.

11. An electronic device comprising:
at least one processing device configured to:
receive two-dimensional (2D) hue-saturation color metadata corresponding to high dynamic range (HDR) source content;
perform a scene-adaptive color enhancing process to build a saturation enhancing model based on the 2D hue-saturation color metadata;
perform hue interpolation, based on the saturation enhancing model, to preserve color hue accuracy while enhancing saturation; and
generate, based on the HDR source content and the hue interpolation, output image data corresponding to the HDR source content and having enhanced color content.

12. The electronic device of claim 11, wherein the scene-adaptive color enhancing process includes generating one or more cumulative distribution function (CDF) curves in a saturation dimension based on the 2D hue-saturation color metadata.

13. The electronic device of claim 12, wherein the scene-adaptive color enhancing process further includes dynamically shifting the one or more CDF curves in the saturation dimension in accordance with one or more scene-adaptive lookup tables (LUTs).

14. The electronic device of claim 12, wherein the scene-adaptive color enhancing process is configured to use the 2D hue-saturation color metadata based on the one or more CDF curves in the saturation dimension.

15. The electronic device of claim 11, wherein the 2D hue-saturation color metadata comprises a histogram generated from the HDR source content with fixed hue quantization boundaries and dynamically-determined saturation boundaries.

16. The electronic device of claim 15, wherein:
the fixed hue quantization boundaries comprise six hue ranges; and
the dynamically-determined saturation boundaries comprise five saturation divisions.

17. The electronic device of claim 11, wherein, to perform the scene-adaptive color enhancing process, the at least one processing device is configured to generate cumulative distribution function (CDF) curves along a saturation dimension from the 2D hue-saturation color metadata.

18. The electronic device of claim 17, wherein, to perform the hue interpolation, the at least one processing device is configured, for a plurality of hue values extracted from the HDR source content, to interpolate an augmented CDF matrix in two dimensions to obtain CDF values for the plurality of hue values.

19. The electronic device of claim 17, wherein:
the at least one processing device is further configured to shift the CDF curves by applying a horizontal shift to saturation control points and a vertical shift to CDF values to produce shifted CDF curves;
the horizontal shift is based on slope values of the CDF curves across saturation ranges; and
the vertical shift is based on a fraction of a CDF value range.

20. A non-transitory machine readable medium containing instructions that when executed cause at least one processor of an electronic device to:
receive two-dimensional (2D) hue-saturation color metadata corresponding to high dynamic range (HDR) source content;
perform a scene-adaptive color enhancing process to build a saturation enhancing model based on the 2D hue-saturation color metadata;
perform hue interpolation, based on the saturation enhancing model, to preserve color hue accuracy while enhancing saturation; and
generate, based on the HDR source content and the hue interpolation, output image data corresponding to the HDR source content and having enhanced color content.
